(19) United States
(12) Patent Application Publication
(10) Pub. No.: US 2026/0200268 A1
(43) Pub. Date: Jul. 16, 2026

(54) RUBBER COMPOSITION

(71) Applicant: Compagnie Generale Des Etablissements Michelin, Clermont-Ferrand (FR)

(72) Inventors: Kahina MAMMERI, Clermont-Ferrand (FR); François JEAN-BAPTISTE-DIT-DOMINIQUE, Clermont-Ferrand (FR)

(73) Assignee: Compagnie Generale Des Etablissements Michelin, Clermont-Ferrand (FR)

(21) Appl. No.: 19/136,039

(22) PCT Filed: Dec. 5, 2023
(86) PCT No.: PCT/EP2023/084252

§ 371 Date: Jun. 5, 2025

(30) Foreign Application Priority Data
Dec. 8, 2022 (FR) 2212976

(51) Int. Cl. B60C 1/00; C07F 7/18; C08F 236/04; C08F 236/06; C08K 3/014; C08K 3/22; C08K 3/24; C08K 3/36; C08K 5/44; C08K 5/5455; C08L 9/00

(52) U.S. Cl. CPC B60C 1/0016; C07F 7/1896; C08F 236/045; C08F 236/06; C08K 3/014; C08K 3/22; C08K 3/24; C08K 3/36; C08K 5/44; C08K 5/5455; C08L 9/00; C08K 2003/2296

(57) ABSTRACT

The invention relates to a rubber composition which comprises a highly saturated diene elastomer. The elastomer is a copolymer of ethylene and of a 1,3-diene comprising ethylene units which represent more than 50 mol % of the monomer units of the copolymer, a vulcanization system, a reinforcing filler containing a silica, and an azosilane coupling agent.

### CROSS REFERENCE TO RELATED APPLICATIONS

This U.S. patent application is a national phase entry of PCT Patent Application No. PCT/EP2023/084252, filed Dec. 5, 2023, which claims priority to French Patent Application No. FR 2212976, filed Dec. 8, 2022, the entire contents of which are incorporated herein by reference in their entirety.

### BACKGROUND

### 1. Technical Field

The field of the present invention is that of rubber compositions which comprise a silica and a highly saturated diene elastomer and which are notably intended for use in tire manufacture.

### 2. Related Art

Rubber compositions reinforced with a silica and comprising a highly saturated diene elastomer are known for example from documents WO 2014114607 A1 and WO 2018224776 A1. The highly saturated diene elastomer is a copolymer of ethylene and a 1,3-diene such as 1,3-butadiene and has the distinctive feature of containing more than 50 mol % of ethylene units. Due to its high ethylene content and low diene unit content of less than 50 mol %, it differs greatly from diene elastomers conventionally used in rubber compositions, which generally contain more than 50 mol % of diene units, such as polybutadienes, polyisoprenes and copolymers of 1,3-butadiene or isoprene and styrene. It notably has the distinctive feature of giving a rubber composition a property compromise between stiffness and hysteresis which is different from that given by the diene elastomers traditionally used.

Since savings in fuel and the need to protect the environment have become a priority, it is desirable to produce mixtures having good wear resistance properties while having a hysteresis which is as low as possible in order to be able to process them in the form of rubber compositions which may be used in the manufacture of various semi-finished products involved in the composition of tires, such as for example treads, in order to obtain tires having an improved wear resistance without adversely affecting the rolling resistance.

To improve the wear resistance, it is known that a certain stiffness of the tread is desirable, it being possible for this stiffening of the tread to be obtained for example by increasing the content of reinforcing filler in the rubber compositions making up these treads. Unfortunately, experience shows that such stiffening of the tread has a known, and usually prohibitive, adverse effect on the rolling resistance properties, since it is accompanied by a significant increase in hysteresis losses of the rubber composition.

Improving the stiffness performance while retaining low rolling resistance is therefore a constant concern for tire designers. In light of the above, it is a general aim to provide rubber compositions for tires which satisfy an improved compromise in properties between stiffness and hysteresis for use in tires, notably in treads, in order to improve the performance compromise between wear and rolling resistance.

The inventors have discovered a rubber composition combining both a very high level of stiffness and a very low level of hysteresis.

Thus, the invention relates to a rubber composition which comprises:
a highly saturated diene elastomer which is a copolymer of ethylene and of a 1,3-diene comprising ethylene units which represent more than 50 mol % of the monomer units of the copolymer,
a vulcanization system,
a reinforcing filler containing a silica,
and a silane coupling agent of formula (1)

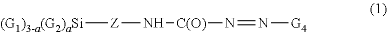

in which:
G₁, which are identical or different, each represent a C₁-C₈ alkyl group,
G₂, which are identical or different, each represent a hydroxyl group or a C₁-C₈ alkoxy group,
G₄ represents an aromatic group,
Z represents a C₁-C₈ alkanediyl group,
a is equal to 1, 2 or 3.

The invention also relates to a tire which comprises a rubber composition in accordance with the invention, preferentially in its tread.

### DETAILED DESCRIPTION

Any interval of values denoted by the expression “between a and b” represents the range of values greater than “a” and less than “b” (that is to say, limits a and b excluded), whereas any interval of values denoted by the expression “from a to b” means the range of values extending from “a” up to “b” (that is to say, including the strict limits a and b).

The abbreviation “phr” means parts by weight per hundred parts of elastomer (of the total of the elastomers if several elastomers are present).

In the present disclosure of the invention, the designation “a Cₙ-Cₘ group” is used to denote a group having n to m carbon atoms, n being an integer greater than or equal to 1, m being an integer greater than n. By way of example, a C₁-C₈ alkyl group denotes an alkyl radical having 1 to 8 carbon atoms, a C₁-C₈ alkoxy group denotes an alkoxy radical having 1 to 8 carbon atoms, a C₁-C₈ alkanediyl group denotes an alkanediyl radical having 1 to 8 carbon atoms, and a C₆-C₁₂ aryl group denotes an aryl radical having 6 to 12 carbon atoms.

The compounds mentioned in the description may be of fossil origin or may be biobased. In the latter case, they may be, partially or completely, derived from biomass or may be obtained from renewable starting materials derived from biomass. In the same way, the compounds mentioned can also originate from the recycling of pre-used materials, that is to say that they can, partially or completely, result from a recycling process, or else be obtained from starting materials which themselves result from a recycling process.

In the present invention, the term “tire” is understood to mean a pneumatic or non-pneumatic tire. A pneumatic tire usually includes two beads intended to come into contact with a rim, a crown composed of at least one crown reinforcement and a tread, two sidewalls, the tire being reinforced by a carcass reinforcement anchored in the two beads. A non-pneumatic tire, for its part, usually comprises a base, designed for example for mounting on a rigid rim, a crown reinforcement, ensuring the connection with a tread and a deformable structure, such as spokes, ribs or cells, this structure being placed between the base and the crown. Such non-pneumatic tires do not necessarily include a sidewall. Non-pneumatic tires are described for example in documents WO 03/018332 and FR2898077. According to any one of the embodiments of the invention, the tire according to the invention is preferentially a pneumatic tire.

Unless otherwise indicated, the contents of the units resulting from the insertion of a monomer into a copolymer such as the copolymer that is useful for the invention are expressed as a molar percentage relative to all of the monomer units of the copolymer.

The elastomer that is useful for the purposes of the invention is a highly saturated diene elastomer, which is preferably statistical, which comprises ethylene units resulting from the polymerization of ethylene. In a known manner, the expression “ethylene unit” refers to the —(CH₂—CH₂)— unit resulting from the insertion of ethylene into the elastomer chain. The highly saturated diene elastomer is rich in ethylene units, since the ethylene units represent more than 50 mol % of all of the monomer units of the elastomer.

Preferably, the highly saturated diene elastomer comprises at least 60 mol % of ethylene units, preferentially at least 65 mol % of ethylene units. In other words, the ethylene units in the highly saturated diene elastomer preferentially represent at least 60 mol % of all of the monomer units of the highly saturated diene elastomer, more preferentially at least 65 mol % of all of the monomer units of the highly saturated diene elastomer.

Preferably, the ethylene units in the highly saturated diene elastomer represent not more than 90 mol % of all of the monomer units of the highly saturated diene elastomer. More preferentially, the ethylene units represent not more than 85 mol % of all of the monomer units of the highly saturated diene elastomer. Even more preferentially, the ethylene units represent not more than 80 mol % of all of the monomer units of the highly saturated diene elastomer.

According to an advantageous embodiment, the highly saturated diene elastomer comprises from 60 mol % to 90 mol % of ethylene units, particularly from 60 mol % to 85 mol % of ethylene units, the molar percentage being calculated on the basis of all of the monomer units of the highly saturated diene elastomer. More advantageously, the highly saturated diene elastomer comprises from 60 mol % to 80 mol % of ethylene units, the molar percentage being calculated on the basis of all of the monomer units of the highly saturated diene elastomer.

According to another advantageous embodiment, the highly saturated diene elastomer comprises from 65 mol % to 90 mol % of ethylene units, particularly from 65 mol % to 85 mol % of ethylene units, the molar percentage being calculated on the basis of all of the monomer units of the highly saturated diene elastomer. More advantageously, the highly saturated diene elastomer comprises from 65 mol % to 80 mol % of ethylene units, the molar percentage being calculated on the basis of all of the monomer units of the highly saturated diene elastomer.

Since the highly saturated diene elastomer is a copolymer of ethylene and of a 1,3-diene, it also comprises 1,3-diene units resulting from the polymerization of a 1,3-diene. In a known manner, the expression “1,3-diene unit” or “diene unit” refers to units resulting from the insertion of 1,3-diene via a 1,4 addition, a 1,2 addition or a 3,4 addition in the case of isoprene, for example. The 1,3-diene units are those, for example, of a 1,3-diene containing 4 to 12 carbon atoms, such as 1,3-butadiene, isoprene, 1,3-pentadiene or an aryl-1,3-butadiene. Preferably the 1,3-diene is 1,3-butadiene or a mixture of 1,3-dienes, one of which is 1,3-butadiene. More preferentially, the 1,3-diene is 1,3-butadiene, in which case the highly saturated diene elastomer is a copolymer of ethylene and of 1,3-butadiene, which is preferably statistical.

The highly saturated diene elastomer can be obtained according to various synthetic methods known to those skilled in the art, notably as a function of the targeted microstructure of the highly saturated diene elastomer. Generally, it can be prepared by copolymerization at least of a 1,3-diene, preferably 1,3-butadiene, and of ethylene and according to known synthetic methods, in particular in the presence of a catalytic system comprising a metallocene complex. Mention may be made in this respect of catalytic systems based on metallocene complexes, which catalytic systems are described in EP 1 092 731, WO 2004/035639, WO 2007/054223 and WO 2007/054224 in the name of the Applicant. The highly saturated diene elastomer, including the case when it is statistical, may also be prepared via a process using a catalytic system of preformed type such as those described in WO 2017/093654 A1, WO 2018/020122 A1 and WO 2018/020123 A1. Advantageously, the diene elastomer is statistical and is preferentially prepared via a semi-continuous or continuous process as described in documents WO 2017103543 A1, WO 201713544 A1, WO 2018193193 and WO 2018193194.

The highly saturated diene elastomer preferably contains units of formula (I) or units of formula (II).

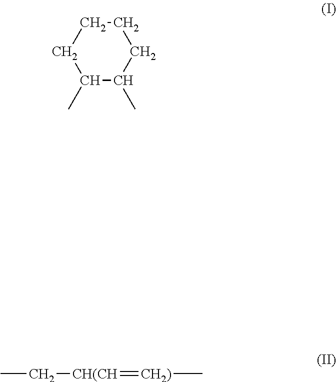

The presence of a saturated 6-membered ring unit, 1,2-cyclohexanediyl, of formula (I) in the copolymer may result from a series of very specific insertions of ethylene and of 1,3-butadiene into the polymer chain during its growth. When the highly saturated diene elastomer comprises units of formula (I) or units of formula (II), the molar percentages of the units of formula (I) and of the units of formula (II) in the highly saturated diene elastomer, o and p respectively, preferably satisfy the following equation (eq. 1) or equation (eq. 2), o and p being calculated on the basis of all of the monomer units of the highly saturated diene elastomer.

$$0 < o + p \leq 30 \qquad ( eq . 1 )$$

$$0 < o + p < 25 \qquad ( eq . 2 )$$

Preferably, the highly saturated diene elastomer comprises units of formula (I) in a molar content greater than 0 mol % and less than 15 mol %, more preferentially less than 10 mol %, the molar percentage being calculated on the basis of all of the monomer units of the highly saturated diene elastomer.

In addition to the highly saturated diene elastomer, the rubber composition may contain a second diene elastomer. The term “diene elastomer” means an elastomer derived at least in part (i.e. a homopolymer or a copolymer) from diene monomer units (monomers bearing two conjugated or non-conjugated carbon-carbon double bonds). The second elastomer may be chosen from the group of highly unsaturated diene elastomers consisting of polybutadienes, polyisoprenes, butadiene copolymers, isoprene copolymers and a mixture thereof. A highly unsaturated elastomer is one which contains more than 50% mol % of diene units.

Preferably, the content of the highly saturated diene elastomer in the rubber composition is at least 50 parts by weight per hundred parts of elastomer of the rubber composition (phr). More preferentially, the content of the highly saturated diene elastomer in the rubber composition varies in a range extending from 80 to 100 phr. Even more preferentially, it varies in a range extending from 90 to 100 phr. It is advantageously 100 phr. The highly saturated diene elastomer may be a single highly saturated diene elastomer or a mixture of highly saturated diene elastomers which differ from each other in their microstructures or in their macrostructures. In the case where the rubber composition contains several highly saturated diene elastomers which differ from each other in their microstructures or in their macrostructures, the content of the highly saturated diene elastomer in the rubber composition refers to the mixture of highly saturated diene elastomers.

The silica used may be any reinforcing silica known to those skilled in the art, notably any precipitated or fumed silica having a BET specific surface area and also a CTAB specific surface area both of less than 450 m²/g, preferably in a range extending from 30 to 400 m²/g, notably from 60 to 300 m²/g. In the present disclosure, the BET specific surface area is determined by gas adsorption using the Brunauer-Emmett-Teller method described in “The Journal of the American Chemical Society”, (vol. 60, page 309, February 1938), and more specifically according to a method derived from the standard NF ISO 5794-1, appendix E, of June 2010 [multipoint (5 point) volumetric method—gas: nitrogen—degassing under vacuum: one hour at 160° C.—relative pressure p/po range: 0.05 to 0.17]. The CTAB specific surface area values were determined according to the standard NF ISO 5794-1, appendix G of June 2010. The process is based on the adsorption of CTAB (N-hexadecyl-N,N,N-trimethylammonium bromide) on the “outer” surface of the reinforcing filler.

Use may be made of any type of precipitated silica, notably highly dispersible precipitated silicas (HDS, for “highly dispersible silica”). These precipitated silicas, which may or may not be highly dispersible, are well known to those skilled in the art. Mention may be made, for example, of the silicas described in patent applications WO 03/016215-A1 and WO 03/016387-A1. Among the commercial HDS silicas, use may notably be made of the Ultrasil® 5000GR and Ultrasil® 7000GR silicas from the company Evonik or the Zeosil® 1085GR, Zeosil® 1115 MP, Zeosil® 1165MP, Zeosil® Premium 200MP and Zeosil® HRS 1200 MP silicas from the company Solvay. Use may be made, as non-HDS silica, of the following commercial silicas: the Ultrasil® VN2GR and Ultrasil® VN3GR silicas from the company Evonik, the Zeosil® 175GR silica from the company Solvay or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from the company PPG.

The reinforcing filler may comprise any type of “reinforcing” filler other than silica, known for its capacity to reinforce a rubber composition which can be used in particular for the manufacture of tires, for example a carbon black. Suitable carbon blacks include all carbon blacks, notably the blacks conventionally used in tires or their treads. Among said carbon blacks, mention will more particularly be made of the reinforcing carbon blacks of the 100, 200 and 300 series, or the blacks of the 500, 600 or 700 series (ASTM D-1765-2017 grades), for instance the N115, N134, N234, N326, N330, N339, N347, N375, N550, N683 and N772 blacks. These carbon blacks may be used in isolated form, as commercially available, or in any other form, for example as support for some of the rubber engineering additives used. When carbon black is used in the rubber composition, it is preferably present in a content of less than or equal to 10 phr (for example, the carbon black content may be in a range from 1 to 10 phr). Advantageously, the carbon black content in the rubber composition is less than or equal to 5 phr. Within the intervals indicated, the coloring properties (black pigmenting agent) and UV-stabilizing properties of the carbon blacks are exploited, without otherwise adversely affecting the typical performance qualities contributed by the silica.

Silica preferentially represents more than 50% by mass of the reinforcing filler. In other words, the proportion of silica in the reinforcing filler is greater than 50% by weight relative to the total weight of the reinforcing filler. More preferentially, the silica represents more than 85% by mass of the reinforcing filler.

The total content of reinforcing filler may vary over a wide range, for example from 30 phr to 150 phr. According to a first embodiment, the total content of reinforcing filler varies in a range extending from 30 phr to 60 phr. According to a second embodiment, the total content of reinforcing filler varies in a range extending from over 60 phr to 150 phr. The first embodiment is preferred to the second embodiment for use of the rubber composition in a tread with very low rolling resistance. Any one of these ranges of total content of reinforcing filler may apply to any of the embodiments of the invention.

The rubber composition in accordance with the invention has the essential feature of comprising a silane of formula (1)

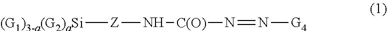

in which:
G₁, which are identical or different, each represent a C₁-C₈ alkyl group,
G₂, which are identical or different, each represent a hydroxyl group or a C₁-C₈ alkoxy group,
G₄ represents an aromatic group,
Z represents a C₁-C₈ alkanediyl group,
a is equal to 1, 2 or 3.

The silane of formula (1) is a coupling agent (or bonding agent) intended to ensure a sufficient connection, of a chemical and/or physical nature, between the silica and the diene elastomer.

Preferably, G₂, which are identical or different, each represent a C₁-C₄ alkoxy group. More preferentially, G₂, which are identical or different, each represent a methoxy or ethoxy group.

Preferably, G₁, which are identical or different, each represent a methyl or ethyl group.

G₄ is an aromatic hydrocarbon group or an aromatic group containing a heteroatom such as a nitrogen, oxygen or sulfur atom. Preferably, G₄ is a C₆-C₁₂ aryl group; more preferentially, G₄ represents a phenyl or tolyl group.

Preferably, Z represents a C₁-C₄ alkanediyl group. More preferentially, Z represents a 1,3-propanediyl group.

According to any one of the embodiments of the invention, a is preferentially equal to 3.

Advantageously, the silane coupling agent of formula (1) is a compound in which G₂ each represent an ethoxy group, G₁ each represent a methyl group, G₄ represents a phenyl group, Z represents a 1,3-propanediyl group and a is equal to 1, 2 or 3. More advantageously, the silane coupling agent of formula (1) is a compound in which G₂ each represent an ethoxy group, G₄ represents a phenyl group, Z represents a 1,3-propanediyl group and a is equal to 3.

The silane coupling agent of formula (1) may be prepared according to the synthetic processes described in patent application WO2015162053A1.

In the rubber composition in accordance with the invention, the content of silane coupling agent of formula (1) is adjusted by those skilled in the art according to the specific surface area of the silica used in the rubber composition and according to the silica content in the rubber composition. According to any one of the embodiments of the invention, it preferentially ranges from 1 to 15 phr, more preferentially from 1.5 to 10 phr, even more preferentially from 2 to 5 phr.

Another essential feature of the rubber composition in accordance with the invention is that of containing a vulcanization system, that is to say a sulfur-based crosslinking system. The sulfur is typically provided in the form of molecular sulfur or of a sulfur-donating agent, preferably in molecular form. Sulfur in molecular form is also referred to by the term “molecular sulfur”. The term “sulfur donor” means any compound which releases sulfur atoms, optionally combined in the form of a polysulfide chain, which are capable of inserting into the polysulfide chains formed during the vulcanization and bridging the elastomer chains. Various known secondary vulcanization accelerators or vulcanization activators, such as zinc oxide, stearic acid, etc. are added to the vulcanization system, being incorporated during the first non-productive phase and/or during the productive phase. The sulfur content is preferably between 0.5 and 4 phr and the primary accelerator content is preferably between 0.5 and 5 phr. These preferential contents may apply to any one of the embodiments of the invention.

Use may be made, as (primary or secondary) vulcanization accelerator, of any compound that is capable of acting as accelerator of the vulcanization of diene elastomers in the presence of sulfur, notably accelerators of the thiazole type and also derivatives thereof, accelerators of the sulfenamide type as regards the primary accelerators, or of the thiuram, dithiocarbamate, dithiophosphate, thiourea and xanthate type as regards the secondary accelerators. As examples of primary accelerators, mention may notably be made of sulfenamide compounds such as N-cyclohexyl-2-benzothiazylsulfenamide (“CBS”), N, N-dicyclohexyl-2-benzothiazylsulfenamide (“DCBS”), N-tert-butyl-2-benzothiazylsulfenamide (“TBBS”), and mixtures of these compounds. The primary accelerator is preferentially a sulfenamide, more preferentially N-cyclohexyl-2-benzothiazylsulfenamide. As examples of secondary accelerators, mention may notably be made of thiuram disulfides such as tetraethylthiuram disulfide, tetrabutylthiuram disulfide (“TBTD”), tetrabenzylthiuram disulfide (“TBZTD”) and mixtures of these compounds. The secondary accelerator is preferentially a thiuram disulfide, more preferentially tetrabenzylthiuram disulfide.

The vulcanization is performed in a known manner at a temperature generally of between 130° C. and 200° C., for a sufficient time which may vary for example between 5 and 90 min notably depending on the curing temperature, the vulcanization system adopted and the vulcanization kinetics of the composition under consideration.

The rubber composition in accordance with the invention may also comprise all or some of the usual additives customarily used in elastomer compositions intended for tire manufacture, notably pigments, protective agents, such as antiozone waxes, chemical antiozonants, antioxidants or plasticizers such as plasticizing oils or resins.

The rubber composition, before vulcanization, may be manufactured in appropriate mixers, using two successive phases of preparation according to a procedure well known to those skilled in the art: a first phase of thermomechanical working or kneading (sometimes referred to as a “non-productive” phase) at high temperature, up to a maximum temperature of between 110° C. and 190° C., preferably between 130° C. and 180° C., followed by a second phase of mechanical working (sometimes referred to as a “productive” phase) at lower temperature, typically below 110° C., for example between 40° C. and 100° C., during which finishing phase the sulfur or the sulfur donor and the vulcanization accelerator are incorporated.

By way of example, the first (non-productive) phase is performed in a single thermomechanical step during which all the necessary constituents, the optional supplementary processing aids and various other additives, with the exception of the vulcanization system, are introduced into an appropriate mixer, such as an ordinary internal mixer. The total kneading time in this non-productive phase is preferably between 1 and 15 minutes. After cooling the mixture thus obtained during the first non-productive phase, the vulcanization system is then incorporated at low temperature, generally into an external mixer such as an open mill; the whole is then mixed (productive phase) for a few minutes, for example between 2 and 15 minutes.

The rubber composition may be calendered or extruded in the form of a sheet or a slab, notably for laboratory characterization, or else in the form of a rubber semi-finished product (or profiled element) that can be used in a tire. The composition may be either in the green state (before crosslinking or vulcanization), or in the cured state (after crosslinking or vulcanization). It may consist of all or some of a semi-finished article, in particular intended for use in a pneumatic or non-pneumatic tire which includes a tread, notably in the tire tread.

To sum up, the invention is advantageously implemented according to any one of the following Embodiments 1 to 29:

Embodiment 1: Rubber composition which comprises:
a highly saturated diene elastomer which is a copolymer of ethylene and of a 1,3-diene comprising ethylene units which represent more than 50 mol % of the monomer units of the copolymer,
a vulcanization system,
a reinforcing filler containing a silica,
and a silane coupling agent of formula (1)

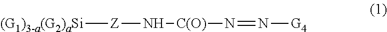

in which:
G₁, which are identical or different, each represent a C₁-C₈ alkyl group,
G₂, which are identical or different, each represent a hydroxyl group or a C₁-C₈ alkoxy group,
G₄ represents an aromatic or heteroaromatic group,
Z represents a C₁-C₈ alkanediyl group,
a is equal to 1, 2 or 3.

Embodiment 2: Rubber composition according to Embodiment 1, in which the 1,3-diene is 1,3-butadiene or a mixture of 1,3-dienes, one of which is 1,3-butadiene.

Embodiment 3: Rubber composition according to Embodiment 1 or 2, in which the 1,3-diene is 1,3-butadiene.

Embodiment 4: Rubber composition according to any one of Embodiments 1 to 3, in which the ethylene units of the highly saturated diene elastomer represent at least 60 mol % of all of the monomer units of the highly saturated diene elastomer.

Embodiment 5: Rubber composition according to any one of Embodiments 1 to 4, in which the ethylene units of the highly saturated diene elastomer represent at least 65 mol % of all of the monomer units of the highly saturated diene elastomer.

Embodiment 6: Rubber composition according to any one of Embodiments 1 to 5, in which the ethylene units of the highly saturated diene elastomer represent at least 70 mol % of all of the monomer units of the highly saturated diene elastomer.

Embodiment 7: Rubber composition according to any one of Embodiments 1 to 6, in which the ethylene units of the highly saturated diene elastomer represent not more than 90 mol % of all of the monomer units of the highly saturated diene elastomer.

Embodiment 8: Rubber composition according to any one of Embodiments 1 to 7, in which the ethylene units of the highly saturated diene elastomer represent not more than 85 mol % of all of the monomer units of the highly saturated diene elastomer.

Embodiment 9: Rubber composition according to any one of Embodiments 1 to 8, in which the ethylene units of the highly saturated diene elastomer represent not more than 80 mol % of all of the monomer units of the highly saturated diene elastomer.

Embodiment 10: Rubber composition according to any one of Embodiments 1 to 9, in which the highly saturated diene elastomer contains units of formula (I) or units of formula (II).

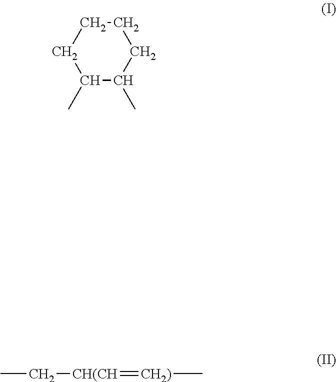

Embodiment 11: Rubber composition according to any one of Embodiments 1 to 10, in which the highly saturated diene elastomer comprises units of formula (I) in a molar content greater than 0 mol % and less than 15 mol %, the molar percentage being calculated on the basis of all of the monomer units of the highly saturated diene elastomer.

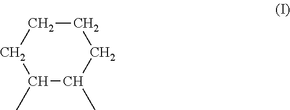

Embodiment 12: Rubber composition according to any one of Embodiments 1 to 11, in which the highly saturated diene elastomer comprises units of formula (I) in a molar content greater than 0 mol % and less than 10 mol %, the molar percentage being calculated on the basis of all of the monomer units of the highly saturated diene elastomer.

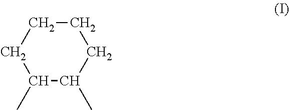

Embodiment 13: Rubber composition according to any one of Embodiments 1 to 12, in which the highly saturated diene elastomer is a statistical copolymer.

Embodiment 14: Rubber composition according to any one of Embodiments 1 to 13, in which the content of the highly saturated diene elastomer is at least 50 parts by weight per hundred parts of elastomer of the rubber composition (phr).

Embodiment 15: Rubber composition according to any one of Embodiments 1 to 14, in which the content of the highly saturated diene elastomer varies in a range extending from 80 to 100 phr.

Embodiment 16: Rubber composition according to any one of Embodiments 1 to 15, in which the total content of reinforcing filler varies in a range extending from 30 to 150 phr.

Embodiment 17: Rubber composition according to any one of Embodiments 1 to 16, in which the total content of reinforcing filler varies in a range extending from 30 phr to 60 phr.

Embodiment 18: Rubber composition according to any one of Embodiments 1 to 17, in which silica represents more than 50% by mass of the reinforcing filler.

Embodiment 19: Rubber composition according to any one of Embodiments 1 to 18, in which silica represents more than 85% by mass of the reinforcing filler.

Embodiment 20: Rubber composition according to any one of Embodiments 1 to 19, in which G₂, which are identical or different, each represent a C₁-C₄ alkoxy group.

Embodiment 21: Rubber composition according to any one of Embodiments 1 to 20, in which G₂, which are identical or different, each represent a methoxy or ethoxy group.

Embodiment 22: Rubber composition according to any one of Embodiments 1 to 21, in which G₁, which are identical or different, each represent a methyl or ethyl group.

Embodiment 23: Rubber composition according to any one of Embodiments 1 to 22, in which G₄ is a C₆-C₁₂ aryl group.

Embodiment 24: Rubber composition according to any one of Embodiments 1 to 23, in which G₄ represents a phenyl or tolyl group.

Embodiment 25: Rubber composition according to any one of Embodiments 1 to 24, in which Z represents a C₁-C₄ alkanediyl group.

Embodiment 26: Rubber composition according to any one of Embodiments 1 to 25, in which Z represents a 1,3-propanediyl group.

Embodiment 27: Rubber composition according to any one of Embodiments 1 to 26, in which a is equal to 3.

Embodiment 28: Tire which comprises a rubber composition defined in any one of Embodiments 1 to 27.

Embodiment 29: Tire which comprises a rubber composition defined in any one of Embodiments 1 to 27 in its tread.

The above-mentioned features of the present invention, and also others, will be understood more clearly on reading the following description of several exemplary embodiments of the invention, which are given as non-limiting illustrations.

### Examples

### Dynamic Properties

The dynamic properties G* and tan(δ)max are measured on a viscosity analyser (Metravib VA4000), according to Standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz, under standard temperature conditions (23° C.) according to Standard ASTM D 1349-99, is recorded. A strain amplitude sweep is performed from 0.1% to 100% (outward cycle) and then from 100% to 0.1% (return cycle). The results made use of are the complex dynamic shear modulus (G*), the loss factor tan(δ) and the difference in modulus ΔG* between the values at 0.1% and 50% strain (Payne effect). For the return cycle, the maximum value of tan(δ) observed, denoted tan(δ)max, is indicated.

The results made use of are the complex shear modulus G*, the loss factor tan(δ) and the difference in modulus ΔG* between the values at 0.1% and 50% strain (Payne effect). For the return cycle, the maximum value of tan(δ) observed, denoted tan(δ)max, is indicated. The complex modulus G* at 50% strain, denoted G*, the difference in modulus ΔG* between the values at 0.1% and 50% strain (Payne effect) and the value of tan(δ)max are given in base 100, the value 100 being assigned to the control composition (T).

Also recorded is the response of the sample of vulcanized composition (cylindrical test specimen with a thickness of 4 mm and a cross section of 400 mm²), subjected to a simple alternating sinusoidal shear stress at an imposed stress of 0.7 MPa and at a frequency of 10 Hz, during a temperature sweep, from a minimum temperature less than the Tg of the elastomers of the compositions up to a maximum temperature greater than 100° C. The results made use of are the complex dynamic shear modulus (G*); the values of G* are taken at the temperature of 60° C.

The stiffness (G*) and hysteresis (tan(δ)max and ΔG*) results are expressed in base 100 relative to a control taken as a reference. A value of less than 100 indicates a lower value than that of the control. The lower the value of ΔG*, the lower the non-linearity which is a source of hysteresis. The lower the value of tan(δ)max, the lower the hysteresis of the rubber composition. The lower the value of G*, the lower the stiffness of the composition.

### Microstructure of the Elastomers by Nuclear Magnetic Resonance (NMR) Analysis:

The microstructure of the elastomers is determined by 1H NMR analysis, combined with 13C NMR analysis when the resolution of the 1H NMR spectra does not enable assignment and quantification of all the species. The measurements are performed using a Bruker 500 MHz NMR spectrometer at frequencies of 500.43 MHz for proton observation and 125.83 MHz for carbon observation.
For the insoluble elastomers which have the ability to swell in a solvent, a 4 mm z-grad HRMAS probe is used for proton and carbon observation in proton-decoupled mode. The spectra are acquired at spin speeds of from 4000 Hz to 5000 Hz.
For the measurements on soluble elastomers, a liquid NMR probe is used for proton and carbon observation in proton-decoupled mode.
The preparation of the insoluble samples is performed in rotors filled with the analyzed material and a deuterated solvent enabling swelling, generally deuterated chloroform (CDCl₃). The solvent used must always be deuterated and its chemical nature may be adapted by a person skilled in the art. The amounts of material used are adjusted so as to obtain spectra of sufficient sensitivity and resolution.
The soluble samples are dissolved in a deuterated solvent (approximately 25 mg of elastomer in 1 ml), in general deuterated chloroform (CDCl₃). The solvent or solvent blend used must always be deuterated and its chemical nature may be adapted by a person skilled in the art.

In both cases (soluble sample or swollen sample):
A 30° single pulse sequence is used for proton NMR. The spectral window is adjusted to observe all the resonance lines belonging to the molecules analyzed. The accumulation number is adjusted in order to obtain a signal to noise ratio that is sufficient for the quantification of each unit. The recycle delay between each pulse is adapted to obtain a quantitative measurement.
For the carbon NMR, a 30° single pulse sequence is used with proton decoupling only during acquisition to avoid the “nuclear Overhauser” effects (NOE) and to remain quantitative. The spectral window is adjusted to observe all the resonance lines belonging to the molecules analyzed. The accumulation number is adjusted in order to obtain a signal to noise ratio that is sufficient for the quantification of each unit. The recycle delay between each pulse is adapted to obtain a quantitative measurement.
The NMR measurements are performed at 25° C.

### Glass Transition Temperature:

The glass transition temperatures, Tg, of the polymers are measured using a differential scanning calorimeter. The analysis is carried out according to the requirements of Standard ASTM D3418-08.

### Mooney Viscosity:

The Mooney viscosity is measured using an oscillating consistometer as described in the standard ASTM D1646 (1999). The measurement is performed according to the following principle: the sample, analyzed in the uncured state (i.e. before curing), is molded (shaped) in a cylindrical chamber heated to a given temperature (100° C.). After preheating for 1 minute, the rotor rotates within the test specimen at 2 revolutions/minute and the working torque for maintaining this movement is measured after rotating for 4 minutes. The Mooney viscosity (ML) is expressed in “Mooney unit” (MU, with 1 MU=0.83 newton.metre).

### Preparation of the Rubber Compositions:

Two rubber compositions are prepared. These compositions are manufactured in the following manner:
The elastomer, then the silica, the silane coupling agent, and also the various other ingredients with the exception of the vulcanization system, are introduced into an internal mixer (final filling level: about 70% by volume), whose initial tank temperature is about 80° C. Thermomechanical working (non-productive phase) is then performed in one step, which lasts approximately 5 min to 6 min, until a maximum “dropping” temperature of 160° C. is reached. The mixture thus obtained is recovered and cooled and then sulfur and an accelerator of sulfenamide type are incorporated on a mixer (homofinisher) at 23° C., everything being mixed (productive phase) for an appropriate time (for example between 5 and 12 min).

The compositions thus obtained are subsequently calendered, either in the form of slabs (with a thickness ranging from 2 to 3 mm) or thin rubber sheets, for the measurement of their physical or mechanical properties after vulcanization at 150° C. (cured state), or in the form of profiled elements which can be used directly, after cutting and/or assembling to the desired dimensions, for example as semi-finished products for tires.

The formulations (in phr) of the rubber compositions are described in Table 2.

The rubber compositions all contain a highly saturated diene elastomer, the elastomer E1, a vulcanization system and a silica. Rubber composition T1 is a control composition since it contains a silane coupling agent, TESPT, that is conventionally used in diene rubber compositions that are reinforced by a silica and intended to be used in a tire. Composition C1, which contains an azosilane coupling agent corresponding to formula (1), is in accordance with the invention. The azosilane is the compound of formula (EtO)₃Si(CH₂)₃—NH—C(═O)—N═N-Ph in which the symbol Ph denotes a phenyl group. It is prepared according to the procedure described in document WO2015162053A1.

The formulations (in phr) of rubber compositions T1 and C1 are described in Table 1. The total sulfur content is identical for each of the rubber compositions, bearing in mind that in the case of rubber composition T1, the coupling agent “Si69” releases free sulfur during its reaction with the elastomer, representing a source of sulfur available for vulcanization, i.e. 0.3 phr. The coupling agents are introduced into the rubber compositions at the same content of alkoxysilane function.

Elastomer E1 is a copolymer of ethylene and of 1,3-butadiene prepared according to the following procedure:
To a 70 L reactor containing methylcyclohexane (64 L), ethylene (5600 g) and 1,3-butadiene (2948 g) are added butyloctylmagnesium (BOMAG) dissolved in methylcyclohexane and the catalytic system. The Mg/Nd ratio is 6.2. The volume of catalytic system solution introduced is 840 mL, the Nd concentration of the catalytic system solution being 0.0065 M. The reaction temperature is regulated to 80° C. and the polymerization reaction begins. The polymerization reaction takes place at a constant pressure of 8.3 bar. The reactor is fed throughout the polymerization with ethylene and 1,3-butadiene in the molar proportions 73/27. The polymerization reaction is stopped by cooling, degassing of the reactor and addition of ethanol. An antioxidant is added to the polymer solution. The copolymer is recovered after steam stripping and drying to constant mass. The polymerization time is 225 minutes. The weighed mass (6.206 kg) makes it possible to determine the mean catalytic activity of the catalytic system, expressed in kilograms of polymer synthesized per mole of neodymium metal and per hour (kg/mol·h). The copolymer has an ML value equal to 62.
The catalytic system is a preformed catalytic system. It is prepared in methylcyclohexane from a metallocene, [Me₂SiFlu₂Nd(μ-BH₄)₂Li(THF)] at 0.0065 mol/L, a co-catalyst, butyloctylmagnesium (BOMAG), the BOMAG/Nd mole ratio of which is equal to 2.2, and a preformation monomer, 1,3-butadiene, the 1,3-butadiene/Nd mole ratio of which is equal to 90. The medium is heated at 80° C. over a period of 5 h. It is prepared according to a preparation method in accordance with paragraph II.1 of patent application WO 2017/093654 A1.

The results of the properties after curing of the rubber compositions are given in Table 2. In comparison with composition T1, composition C1 has a higher stiffness without increased hysteresis; the hysteresis is even greatly reduced.

TABLE 1

| Compositions (in phr) | T1 | C1 |
|---|---|---|
| EBR (1) | 100 | 100 |
| Silica (2) | 38 | 38 |
| Si69 coupling agent (3) | 3.1 | |
| Azosilane coupling agent (4) | | 4.3 |
| Ozone wax (5) | 1 | 1 |
| Antioxidant (6) | 2 | 2 |
| Stearic acid (7) | 2 | 2 |
| ZnO (8) | 2.4 | 2.4 |
| Sulfur | 1 | 1.3 |
| CBS (9) | 1 | 1 |

(1) Copolymer of ethylene and of 1,3-butadiene containing 73.8 mol % of ethylene, 11.9 mol % of 1,2-butadiene units, 6.7 mol % of 1,4-butadiene units and 7.6 mol % of 1,2-cyclohexane rings, with an ML of 62
(2) Zeosil 1165 MP from Solvay-Rhodia, in microbead form
(3) Triethoxysilylpropyl tetrasulfide (TESPT) liquid silane, Si69 from Evonik
(4) Azosilane silane (EtO)₃Si(CH₂)₃—NH—C(═O)—N═N-Ph
(5) Antiozone wax, Varazon 4959 from Sasol Wax
(6) N-(1,3-dimethylbutyl)-N′-phenyl-p-phenylenediamine, Santoflex 6PPD from Flexys
(7) Stearic acid, Pristerene 4931 from Uniqema
(8) Zinc oxide, industrial grade from Umicore
(9) N-Cyclohexyl-2-benzothiazolesulfenamide, Santocure CBS from Flexsys

TABLE 2

| Composition | T1 | C1 |
|---|---|---|
| ΔG 23° C. | 100 | 65 |
| Tanδ max return 23° C. | 100 | 75 |
| G* 60° C. | 100 | 127 |

What is claimed is:

1. A rubber composition which comprises:
a highly saturated diene elastomer which is a copolymer of ethylene and of a 1,3-diene comprising ethylene units which represent more than 50 mol % of the monomer units of the copolymer,
a vulcanization system,
a reinforcing filler containing a silica,
and a silane coupling agent of formula (1) 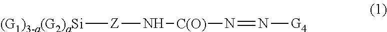
in which:
G₁, which are identical or different, each represent a C₁-C₈ alkyl group,
G₂, which are identical or different, each represent a hydroxyl group or a C₁-C₈ alkoxy group,
G₄ represents an aromatic group,
Z represents a C₁-C₈ alkanediyl group,
a is equal to 1, 2 or 3.

2. The rubber composition according to claim 1, in which the 1,3-diene is 1,3-butadiene or a mixture of 1,3-dienes, one of which is 1,3-butadiene.

3. The rubber composition according to claim 1, in which the ethylene units in the highly saturated diene elastomer represent at least 60 mol % of all of the monomer units of the highly saturated diene elastomer.

4. The rubber composition according to claim 1, in which the ethylene units in the highly saturated diene elastomer represent not more than 90 mol % of all of the monomer units of the highly saturated diene elastomer.

5. The rubber composition according to claim 1, in which the ethylene units in the highly saturated diene elastomer represent not more than 80 mol % of all of the monomer units of the highly saturated diene elastomer.

6. The rubber composition according to claim 1, in which the highly saturated diene elastomer is a statistical copolymer.

7. The rubber composition according to claim 1, in which silica represents more than 50% by mass of the reinforcing filler.

8. The rubber composition according to claim 1, in which G₂, which are identical or different, each represent a C₁-C₄ alkoxy group.

9. The rubber composition according to claim 1, in which G₂, which are identical or different, each represent a methoxy or ethoxy group.

10. The rubber composition according to claim 1, in which G₁, which are identical or different, each represent a methyl or ethyl group.

11. The rubber composition according to claim 1, in which G₄ represents a phenyl or tolyl group.

12. The rubber composition according to claim 1, in which Z represents a C₁-C₄ alkanediyl group.

13. The rubber composition according to claim 1, in which Z represents a 1,3-propanediyl group.

14. The rubber composition according to claim 1, in which a is equal to 3.

15. A which comprises a rubber composition defined in claim 1.

16. The rubber composition according to claim 2, in which the 1,3-diene is 1,3-butadiene.

17. The rubber composition according to claim 3, in which the ethylene units in the highly saturated diene elastomer represent at least 65 mol % of all of the monomer units of the highly saturated diene elastomer.

18. The rubber composition according to claim 4, in which the ethylene units in the highly saturated diene elastomer represent not more than 85 mol % of all of the monomer units of the highly saturated diene elastomer.

19. The rubber composition according to claim 7, in which the silica represents more than 85% by mass of the reinforcing filler.

20. The tire according to claim 15, which includes a tread and comprises the rubber composition in the tread.
